(19) United States
(12) Patent Application Publication
(10) Pub. No.: US 2021/0387864 A1
(43) Pub. Date: Dec. 16, 2021

(54) PROCESS FOR MAKING LITHIATED TRANSITION METAL OXIDE PARTICLES, AND PARTICLES MANUFACTURED ACCORDING TO SAID PROCESS

(71) Applicant: BASF Corporation, Florham Park, NJ (US)

(72) Inventors: William MAYS, Rochester Hills, MI (US); Benjamin REICHMAN, W Bloomfield, MI (US); Martin Lawrence PANCHULA, Beachwood, OH (US)

(21) Appl. No.: 17/309,204

(22) PCT Filed: Nov. 6, 2019
(86) PCT No.: PCT/EP2019/080395

§ 371 Date: May 6, 2021

(30) Foreign Application Priority Data
Nov. 9, 2018 (EP) 18205304.1

(51) Int. Cl. C01G 53/00; H01M 10/0525

(52) U.S. Cl. CPC C01G 53/50; H01M 10/0525; C01P 2006/12; C01P 2006/40; C01P 2002/52; C01P 2004/61

(57) ABSTRACT

Process for making lithiated transition metal oxide particles comprising the steps of: (a) Providing a particulate mixed transition metal precursor comprising Ni and at least one transition metal selected from Co and Mn, and, optionally, at least one further metal selected from Ti, Zr, Mo, W, Al, Mg, Nb, and Ta, (b) mixing said precursor with at least one compound of lithium and at least el one processing additive comprising potassium, (c) treating the mixture obtained according to step (b) at a temperature in the range of from 700 to 1,000° C.

The present invention is directed towards a process for making lithiated transition metal oxide particles comprising the steps of:
(a) Providing a particulate mixed transition metal precursor that is selected from hydroxides, carbonates, oxyhydroxides and oxides of TM wherein TM is a combination of metals according to general formula (I)

(NiₐCo_{b}Mn_{c})_{1-d}M_{d} (I)
wherein
a is in the range of from 0.6 to 0.95,
b is in the range of from 0.025 to 0.2,
c is in the range of from zero to 0.2, and
d is in the range of from zero to 0.1,
M is selected from Mg, Al, Ti, Zr, Mo, W, Al, Mg, Nb, and Ta,
a+b+c=1,
(b) mixing said precursor with at least one compound of lithium and 0.05 to 5% by weight, by weight of at least one processing additive selected from potassium carbonate and potassium bicarbonate, the percentage referring to the entire mixture obtained in step (b),
(c) treating the mixture obtained according to step (b) at a temperature in the range of from 700 to 1,000° C.

In addition, the present invention is directed to electrode materials that contain certain amounts of potassium.

Lithiated transition metal oxides are currently being used as electrode active materials for lithium-ion batteries. Extensive research and developmental work has been performed in the past years to improve properties like charge density, specific energy, but also other properties like the reduced cycle life and capacity loss that may adversely affect the lifetime or applicability of a lithium-ion battery. Additional effort has been made to improve manufacturing methods.

In a typical process for making cathode materials for lithium-ion batteries, first a so-called precursor is being formed by co-precipitating the transition metals as carbonates, oxides or preferably as hydroxides that may or may not be basic. The precursor is then mixed with a lithium salt such as, but not limited to LiOH, Li₂O or especially Li₂CO₃ and calcined (fired) at high temperatures. Lithium salt(s) can be employed as hydrate(s) or in dehydrated form. The calcination—or firing—generally also referred to as thermal treatment or heat treatment of the precursor is usually carried out at temperatures in the range of from 600 to 1,000° C. During the thermal treatment a solid state reaction takes place, and the electrode active material is formed. In cases hydroxides or carbonates are used as precursors the solid state reaction follows a removal of water or carbon dioxide. The thermal treatment is performed in the heating zone of an oven or kiln.

One problem of lithium ion batteries is attributed to undesired reactions on the surface of the cathode active materials. Such reactions may be a decomposition of the electrolyte or the solvent or both. It has thus been tried to protect the surface without hindering the lithium exchange during charging and discharging. Examples are attempts to coat the cathode active materials with, e.g., aluminium oxide or calcium oxide, see, e.g., U.S. Pat. No. 8,993,051.

However, coatings have shortcomings. They usually are made from an insulator. However, coatings usually reduce the electrochemical performance by increasing the electrochemical impedance in the electrochemical cell. In addition, the coating process has a pricing disadvantage due to the added unit operation steps.

It was therefore an objective of the present invention to provide a process by which electrode active materials may be made that show a reduced resistance without an increased resistance build-up upon repeated cycling. It was also an objective to provide electrode active materials that exhibit a reduced resistance without an increased resistance build-up upon repeated cycling.

Accordingly, the process as defined at the outset has been found, hereinafter also referred to as inventive process or as process according to the (present) invention. The inventive process is a process for making an electrode active material. Specifically, the inventive process comprises the steps of:
(a) Providing a particulate mixed transition metal that is defined as outlined above,
(b) mixing said precursor with 0.05 to 5% by weight, by weight of at least one compound of lithium and at least one processing additive comprising potassium, the percentage referring to the entire mixture obtained in step (b),
(c) treating the mixture obtained according to step (b) at a temperature in the range of from 700 to 1,000° C.

The inventive process comprises three steps (a), (b) and (c), in the context of the present invention also referred to as step (a), step (b) and step (c). Steps (a) to (c) will be described in more detail below.

Step (a) includes providing a particulate mixed transition metal precursor. Said precursor is selected from carbonates, mixed oxides, mixed hydroxides and mixed oxyhydroxide of TM wherein TM is a combination of metals according to general formula (I)

(NiₐCo_{b}Mn_{c})_{1-d}M_{d} (I)

with

a being in the range of from 0.3 to 0.95, preferably from 0.6 to 0.95,

b being in the range of from 0.01 to 0.4, preferably from 0.025 to 0.2,

c being in the range of from zero to 0.4, preferably from zero to 0.2, and

d being in the range of from zero to 0.1,

M is selected from Mg, Al, Ti, Zr, Mo, W, Al, Mg, Nb, and Ta,

a+b+c=1.

Most preferably, M is Al and d is from 0.003 to 0.008.

Said precursor may contain traces of metal ions, for example traces of ubiquitous metals such as sodium, calcium or zinc, as impurities but such traces will not be taken into account in the description of the present invention. Traces in this context will mean amounts of 0.05 mol-% or less, referring to the total metal content of said precursor.

Examples of combinations of metals according to general formula (I) are selected from Ni_{0.33}Co_{0.33}Mn_{0.33}, Ni_{0.4}Co_{0.2}Mn_{0.4}, Ni_{0.5}Co_{0.2}Mn_{0.3}, Ni_{0.6}Co_{0.2}Mn_{0.2}, (Ni_{0.85}CO_{0.15})_{0.98}Al_{0.02}, (Ni_{0.85}Co_{0.15})_{0.97}Al_{0.03}, (Ni_{0.85}CO_{0.15})_{0.95}Al_{0.05}, Ni_{0.8}Co_{0.1}Mn_{0.1}, and Ni_{0.7}Co_{0.2}Mn_{0.1} Further examples are (Ni_{0.6}Co_{0.2}Mn_{0.2})_{0.997}Al_{0.003}, (Ni_{0.6}Co_{0.2}Mn_{0.2})_{0.998}Al_{0.002}, (Ni_{0.7}Co_{0.2}Mn_{0.1})_{0.997}Al_{0.003}, (Ni_{0.7}Co_{0.2}Mn_{0.1})_{0.998}Al_{0.002}, (Ni_{0.8}Co_{0.1}Mn_{0.1})_{0.997}Al_{0.003}, (Ni_{0.8}Co_{0.1}Mn_{0.1})_{0.998}Al_{0.002}.

Particularly preferred are TM is selected from Ni_{0.6}Co_{0.2}Mn_{0.2}, Ni_{0.7}Co_{0.2}Mn_{0.1}, Ni_{0.8}Co_{0.1}Mn_{0.1} and Ni_{0.85}Co_{0.1}Mn_{0.05}.

Precursors may be selected from mixtures of metal oxides, mixed metal carbonates or preferably from mixed metal hydroxides or more preferably mixed metal oxyhydroxides.

In one embodiment of the present invention, the mean particle diameter (D50) of said precursor is in the range of from 2 to 20 μm, preferably 4 to 10 μm and even more preferably 5 to 7 μm.

The mean particle diameter (D50) in the context of the present invention refers to the median of the volume-based particle diameter of the secondary particles, as can be determined, for example, by light scattering.

The particle shape of the secondary particles of the precursor is preferably spheroidal, that are particles that have a spherical shape. Spherical spheroidal shall include not just those which are exactly spherical but also those particles in which the maximum and minimum diameter of at least 90% (number average) of a representative sample differ by not more than 10%.

In one embodiment of the present invention, the precursor is comprised of secondary particles that are agglomerates of primary particles. Preferably, the precursor is comprised of spherical secondary particles that are agglomerates of primary particles. Even more preferably, the precursors comprised of spherical secondary particles that are agglomerates of spherical primary particles or platelets. In a preferred embodiment, the average diameter (d50) of the primary particles is in the range of from 2 to 15 μm, preferably 3 to 10 μm.

In one embodiment of the present invention, said precursor has the same composition of TM as the desired electrode active material.

In another embodiment of the present invention, said precursor has a different composition of TM. For example, the ratio of the two or more transition metals selected from Mn, Co and Ni is the same as in the desired electrode active material but element M is missing.

The precursor is preferably provided as powder.

In step (b) of the inventive process, the precursor provided in step (a) is mixed with at least one lithium compound and at least one processing additive selected from potassium carbonate and potassium bicarbonate. Said lithium compound is selected from Li₂O, LiOH, and Li₂CO₃, each as such or as hydrate, for example LiOH.H₂O. Combinations of two or more of said lithium compounds are feasible as well.

In embodiments wherein TM in the precursor is the same as in the desired electrode active material, the molar ratio of TM in the precursor to lithium in the lithium compound is selected approximately in the desired range of the desired compound, for example in the range of 1:(1+x) with x being in the range of from zero to 0.2, preferably 0.01 to 0.1.

Examples of processing additives are selected from potassium bicarbonate and potassium carbonate including mixtures thereof, potassium carbonate being preferred.

In one embodiment of the present invention, the amount of the processing additive is in the range of from 0.05 to 5% by weight, referring to the entire mixture obtained in step (b), preferred are 0.2 to 2.5% by weight.

In one embodiment of the present invention said processing additive has an average particle diameter d50 in the range in the range of from 1 μm to 50 μm.

Examples of suitable apparatuses for performing step (b) are tumbler mixers, high-shear mixers, plough-share mixers and free fall mixers.

In one embodiment of the present invention, mixing in step (b) is performed over a period of 1 minute to 10 hours, preferably 5 minutes to 1 hour.

In one embodiment of the present invention, mixing in step (b) is performed without external heating.

In one embodiment of the present invention, no dopant is added in step (b).

In a special embodiment of the present invention, in step (b) an oxide, hydroxide or oxyhydroxide of Al, Ti or W is added, hereinafter also referred to as dopant.

Such dopant is selected from oxides, hydroxides and oxyhydroxides of Ti, W and especially of Al. Lithium titanate is also a possible source of titanium. Examples of dopants are TiO₂ selected from rutile and anatase, anatase being preferred, furthermore basic titania such as TiO(OH)₂, furthermore LiaTi₅O₁₂, WO₃, Al(OH)₃, Al₂O₃, Al₂O₃.aq, and AlOOH. Preferred are Al compounds such as Al(OH)₃, α-Al₂O₃, γ-Al₂O₃, Al₂O₃.aq, and AlOOH. Even more preferred dopants are Al₂O₃ selected from α-Al₂O₃, γ-Al₂O₃, and most preferred is γ-Al₂O₃.

In one embodiment of the present invention such dopant may have a surface (BET) In the range of from 1 to 200 m²/g, preferably 50 to 150 m²/g. The surface BET may be determined by nitrogen adsorption, for example according to DIN-ISO 9277:2003-05.

In one embodiment of the present invention, such dopant is nanocrystalline. Preferably, the average crystallite diameter of the dopant is 100 nm at most, preferably 50 nm at most and even more preferably 15 nm at most. The minimum diameter may be 4 nm.

In one embodiment of the present invention, such dopant(s) is/are a particulate material with an average diameter (D50) in the range of from 1 to 10 μm, preferably 2 to 4 μm. The dopant(s) is/are usually in the form of agglomerates. Its particle diameter refers to the diameter of said agglomerates.

In a preferred embodiment, dopant(s) are applied in an amount of up to 1.5 mole % (referred to the sum of Ni, Co and Mn), preferably 0.1 up to 0.5 mole %.

Although it is possible to add an organic solvent, for example glycerol or glycol, or water in step (b) it is preferred to perform step (b) in the dry state, that is without addition of water or of an organic solvent.

A mixture is obtained from step (b).

In step (c), the mixture obtained from step (b) is thermally treated at a temperature in the range of from 700 to 1,000° C.

In one embodiment of the present invention, the temperature is ramped up before reaching the desired temperature of from 700 to 1000° C., preferably 750 to 900° C. For example, first the mixture of precursor and lithium compound and processing additive is heated to a temperature in the range of from 100 to 150° C. and then held constant for a time of 10 min to 4 hours, then the temperature is ramped up to 350 to 550° C. and then held constant for a time of 10 min to 4 hours, and then it is raised to 700° C. up to 1000° C.

In one embodiment of the present invention, step (c) is performed in a roller hearth kiln, a pusher kiln, a rotary kiln or pendulum kiln, in a vertical or tunnel kiln or in a pendulum kiln or in a combination of at least two of the foregoing. Rotary kilns have the advantage of a very good homogenization of the material made therein. In roller hearth kilns and in pusher kilns, different reaction conditions with respect to different steps may be set quite easily. In lab scale trials, box-type and tubular furnaces and split tube furnaces are feasible as well.

In one embodiment of the present invention, step (c) is performed in an oxygen-containing atmosphere, for example in a nitrogen-air mixture, in a rare gas-oxygen mixture, in air, in oxygen or in oxygen-enriched air. In a preferred embodiment, the atmosphere in step (c) is selected from air, oxygen and oxygen-enriched air. Oxygen-enriched air may be, for example, a 50:50 by volume mix of air and oxygen. Other options are 1:2 by volume mixtures of air and oxygen, 1:3 by volume mixtures of air and oxygen, 2:1 by volume mixtures of air and oxygen, and 3:1 by volume mixtures of air and oxygen.

In one embodiment of the present invention, step (c) of the present invention is performed under a stream of gas, for example air, oxygen and oxygen-enriched air. Such stream of gas may be termed a forced gas flow. Such stream of gas may have a specific flow rate in the range of from 0.5 to 15 m³/hkg precursor. The volume is determined under normal conditions: 273.15 Kelvin and 1 atmosphere. Said stream of gas is useful for removal of gaseous cleavage products such as water and carbon dioxide.

The inventive process may include further steps such as, but not limited, additional calcination steps a ta temperature in the range of from 800 to 1000° C. subsequently to step (c).

In one embodiment of the present invention, step (c) has a duration in the range of from one hour to 30 hours. Preferred are 10 to 24 hours. The cooling time is neglected in this context.

After thermal treatment in accordance to step (c), the cathode active material so obtained is cooled down before further processing.

By performing the inventive process, electrode active materials with an excellent morphology are obtained. They are free from undesired agglomerates and lumps, and they exhibit depending on the particle diameter distribution of the respective precursor, a narrow particle diameter distribution, excellent processability as well as electrochemical performance such as specific capacity or capacity retention upon cycling.

Electrode active materials obtained from the inventive process also exhibit a comparably large average diameter of their primary particles, for example in the range of from 3 to 15 μm. Without wishing to be bound by any theory, we believe that the comparably large average diameter of their primary particles leads to improved cycling behavior.

In one embodiment of the present invention, further steps are performed to make electrode active materials. In one embodiment of the present invention, the inventive process comprises an additional step (d),
(d) treating said particulate material with an aqueous medium, followed by removing said aqueous medium by a solid-liquid separation method.

In the optional step (d), said particulate material is treated with an aqueous medium. Said aqueous medium may have a pH value in the range of from 2 up to 14, preferably at least 5, more preferably from 7 to 12.5 and even more preferably from 8 to 12.5. The pH value is measured at the beginning of step (d). It is observed that in the course of step (d), the pH value raises to at least 10.

It is preferred that the water hardness of aqueous medium and in particular of the water used for step (d) is at least partially removed, especially calcium. The use of desalinized water is preferred.

In one embodiment of the present invention, step (d) is performed by slurrying the particulate material from step (a) in water followed by removal of the water by a solid-liquid separation method and drying at a maximum temperature in the range of from 50 to 450° C.

In an alternative embodiment of step (d), the aqueous medium used in step (d) may contain ammonia or at least one transition metal salt, for example a nickel salt or a cobalt salt. Such transition metal salts preferably bear counterions that are not detrimental to an electrode active material. Sulfate and nitrate are feasible. Chloride is not preferred.

In one embodiment of the present invention, step (d) is performed at a temperature in the range of from 5 to 85° C., preferred are 10 to 60° C.

In one embodiment of the present invention, step (d) is performed at normal pressure. It is preferred, though, to perform step (d) under elevated pressure, for example at 10 mbar to 10 bar above normal pressure, or with suction, for example 50 to 250 mbar below normal pressure, preferably 100 to 200 mbar below normal pressure.

Step (d) may be performed, for example, in a vessel that can be easily discharged, for example due to its location above a filter device. Such vessel may be charged with starting material followed by introduction of aqueous medium. In another embodiment, such vessel is charged with aqueous medium followed by introduction of starting material. In another embodiment, starting material and aqueous medium are introduced simultaneously.

In one embodiment of the present invention, the volume ratio of starting material and total aqueous medium in step (d) is in the range of from 2:1 to 1:5, preferably from 2:1 to 1:2.

Step (d) may be supported by mixing operations, for example shaking or in particular by stirring or shearing, see below.

In one embodiment of the present invention, step (d) has a duration in the range of from 1 minute to 30 minutes, preferably 1 minute to less than 5 minutes. A duration of 5 minutes or more is possible in embodiments wherein in step (d), water treatment and water removal are performed overlapping or simultaneously.

In one embodiment of step (d), water treatment and water removal are performed consecutively. After the treatment with an aqueous medium in accordance to step (d), water may be removed by any type of filtration, for example on a band filter or in a filter press.

In one embodiment of the present invention, at the latest 3 minutes after commencement of step (d), water removal is started. Water removal includes removing said aqueous medium from treated particulate material by way of a solid-liquid separation, for example by decanting or preferably by filtration.

In one embodiment of the present invention, the slurry obtained in step (d) is discharged directly into a centrifuge, for example a decanter centrifuge or a filter centrifuge, or on a filter device, for example a suction filter or in a belt filter that is located preferably directly below the vessel in which step (d) is performed. Then, filtration is commenced.

In a particularly preferred embodiment of the present invention, step (d) is performed in a filter device with stirrer, for example a pressure filter with stirrer or a suction filter with stirrer. At most 3 minutes after—or even immediately after—having combined starting material and aqueous medium in accordance with step (d), removal of aqueous medium is commenced by starting the filtration. On laboratory scale, steps (d) may be performed on a Büchner funnel, and step (d) may be supported by manual stirring.

In a preferred embodiment, step (d) is performed in a filter device, for example a stirred filter device that allows stirring of the slurry in the filter or of the filter cake. By commencement of the filtration, for example pressure filtration or suction filtration, after a maximum time of 3 minutes after commencement of step (d), water removal is started.

In one embodiment of the present invention, the water removal has a duration in the range of from 1 minute to 1 hour.

In one embodiment of the present invention, stirring in step (d) is performed with a rate in the range of from 1 to 50 rounds per minute (“rpm”), preferred are 5 to 20 rpm.

In one embodiment of the present invention, filter media may be selected from ceramics, sintered glass, sintered metals, organic polymer films, non-wovens, and fabrics.

In one embodiment of the present invention, step (d) is carried out under an atmosphere with reduced CO₂ content, e.g., a carbon dioxide content in the range of from 0.01 to 500 ppm by weight, preferred are 0.1 to 50 ppm by weight. The CO₂ content may be determined by, e.g., optical methods using infrared light. It is even more preferred to perform step (d) under an atmosphere with a carbon dioxide content below detection limit for example with infrared-light based optical methods.

Subsequently, the water-treated material is dried, for example at a temperature in the range of from 40 to 250° C. at a normal pressure or reduced pressure, for example 1 to 500 mbar. If drying under a lower temperature such as 40 to 100° C. is desired a strongly reduced pressure such as from 1 to 20 mbar is preferred.

In one embodiment of the present invention, said drying is carried out under an atmosphere with reduced CO₂ content, e.g., a carbon dioxide content in the range of from 0.01 to 500 ppm by weight, preferred are 0.1 to 50 ppm by weight. The CO₂ content may be determined by, e.g., optical methods using infrared light. It is even more preferred to perform step (d) under an atmosphere with a carbon dioxide content below detection limit for example with infrared-light based optical methods.

In one embodiment of the present invention said drying has a duration in the range of from 1 to 10 hours, preferably 90 minutes to 6 hours.

In one embodiment of the present invention, the lithium content of an electrode active material is reduced by 1 to 5% by weight, preferably 2 to 4% is reduced by performing step (d). Said reduction mainly affects the so-called residual lithium.

In a preferred embodiment of the present invention, the material obtained from step (d) has a residual moisture content in the range of from 50 to 1,200 ppm, preferably from 100 to 400 ppm. The residual moisture content may be determined by Karl-Fischer titration.

A further aspect of the present invention relates to an electrode active material, hereinafter also referred to as inventive electrode active material. Inventive electrode active material is in particulate form, and it has the general formula Li₁₊ₓK_{y}TM_{1-x-y}O₂, wherein TM is a combination of Ni and at least one transition metal selected from Co and Mn, and, optionally, at least one further metal selected from Ti, Zr, Mo, W, Al, Mg, Nb, and Ta, and x is in the range of from 0.002 to 0.1, wherein y is in the range of from 0.01 to 0.1, preferably up to 0.05, and wherein the average diameter (d50) of the primary particles is in the range of from 2 to 15 μm, preferably 3 to 10 μm.

In one embodiment of the present invention inventive electrode active materials have an average particle diameter (D50) in the range of from 3 to 20 μm, preferably from 5 to 16 μm. The average particle diameter may be determined, e. g., by light scattering or LASER diffraction or electroacoustic spectroscopy. The particles are usually composed of agglomerates from primary particles, and the above particle diameter refers to the secondary particle diameter.

In a preferred embodiment of the present invention, the secondary particles are composed of 2 to 35 primary particles on average.

In one embodiment of the present invention, some K⁺ is located in sites of Li⁺ in the crystal structure of the inventive electrode active material, for example determined by X-Ray diffraction.

In one embodiment of the present invention inventive electrode active materials have a surface (BET) in the range of from 0.1 to 0.8 m²/g, determined according to DIN-ISO 9277:2003-05.

A further aspect of the present invention refers to electrodes comprising at least one electrode material active according to the present invention. They are particularly useful for lithium ion batteries. Lithium ion batteries comprising at least one electrode according to the present invention exhibit a good discharge behavior. Electrodes comprising at least one electrode active material according to the present invention are hereinafter also referred to as inventive cathodes or cathodes according to the present invention.

Cathodes according to the present invention can comprise further components. They can comprise a current collector, such as, but not limited to, an aluminum foil. They can further comprise conductive carbon and a binder.

Suitable binders are preferably selected from organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol % of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol % of copolymerized propylene and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder is polybutadiene.

Other suitable binders are selected from polyethylene oxide (PEO), cellulose, carboxymethylcellulose, polyimides and polyvinyl alcohol.

In one embodiment of the present invention, binder is selected from those (co)polymers which have an average molecular weight M_{w} in the range from 50,000 to 1,000,000 g/mol, preferably to 500,000 g/mol.

Binder may be cross-linked or non-cross-linked (co)polymers.

In a particularly preferred embodiment of the present invention, binder is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

Inventive cathodes may comprise 1 to 15% by weight of binder(s), referring to electrode active material. In other embodiments, inventive cathodes may comprise 0.1 up to less than 1% by weight of binder(s).

A further aspect of the present invention is a battery, containing at least one cathode comprising inventive electrode active material, carbon, and binder, at least one anode, and at least one electrolyte.

Embodiments of inventive cathodes have been described above in detail.

Said anode may contain at least one anode active material, such as carbon (graphite), TiO₂, lithium titanium oxide, silicon or tin. Said anode may additionally contain a current collector, for example a metal foil such as a copper foil.

Said electrolyte may comprise at least one non-aqueous solvent, at least one electrolyte salt and, optionally, additives.

Nonaqueous solvents for electrolytes can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20 mol % of one or more C₁-C₄-alkylene glycols. Polyalkylene glycols are preferably polyalkylene glycols having two methyl or ethyl end caps.

The molecular weight M_{w} of suitable polyalkylene glycols and in particular suitable polyethylene glycols can be at least 400 g/mol.

The molecular weight M_{w} of suitable polyalkylene glycols and in particular suitable polyethylene glycols can be up to 5 000 000 g/mol, preferably up to 2 000 000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and in particular 1,3-dioxolane.

Examples of suitable acyclic organic carbonates are dimethyl carbonate, ethyl methyl carbonate and diethyl carbonate.

Examples of suitable cyclic organic carbonates are compounds according to the general formulae (II) and (III)

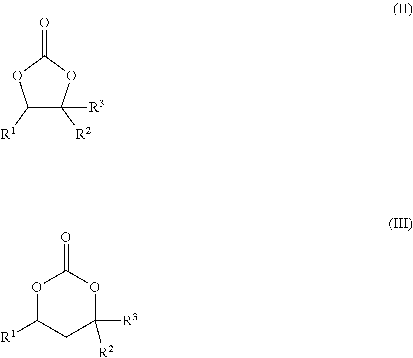

where R¹, R² and R³ can be identical or different and are selected from among hydrogen and C₁-C₄-alkyl, for example methyl, ethyl, n-propyl, isopropyl, n-butyl, isobutyl, sec-butyl and tert-butyl, with R² and R³ preferably not both being tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (IV).

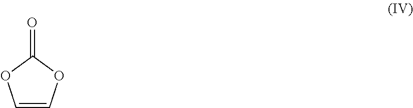

The solvent or solvents is/are preferably used in the water-free state, i.e. with a water content in the range from 1 ppm to 0.1% by weight, which can be determined, for example, by Karl-Fischer titration.

Electrolyte (C) further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄ and salts of the general formula (CₙF₂ₙ₊₁SO₂)ₜYLi, where m is defined as follows:

t=1, when Y is selected from among oxygen and sulfur,

t=2, when Y is selected from among nitrogen and phosphorus, and

t=3, when Y is selected from among carbon and silicon.

Preferred electrolyte salts are selected from among LiC(CF₃SO₂)₃, LiN(CF₃SO₂)₂, LiPF₆, LiBF₄, LiClO₄, with particular preference being given to LiPF₆ and LiN(CF₃SO₂)₂.

In an embodiment of the present invention, batteries according to the invention comprise one or more separators by means of which the electrodes are mechanically separated. Suitable separators are polymer films, in particular porous polymer films, which are unreactive toward metallic lithium. Particularly suitable materials for separators are polyolefins, in particular film-forming porous polyethylene and film-forming porous polypropylene.

Separators composed of polyolefin, in particular polyethylene or polypropylene, can have a porosity in the range from 35 to 45%. Suitable pore diameters are, for example, in the range from 30 to 500 nm.

In another embodiment of the present invention, separators can be selected from among PET nonwovens filled with inorganic particles. Such separators can have porosities in the range from 40 to 55%. Suitable pore diameters are, for example, in the range from 80 to 750 nm.

Batteries according to the invention further comprise a housing which can have any shape, for example cuboidal or the shape of a cylindrical disk or a cylindrical can. In one variant, a metal foil configured as a pouch is used as housing.

Batteries according to the invention display a good discharge behavior, for example at low temperatures (zero ° C. or below, for example down to −10° C. or even less), a very good discharge and cycling behavior.

Batteries according to the invention can comprise two or more electrochemical cells that combined with one another, for example can be connected in series or connected in parallel. Connection in series is preferred. In batteries according to the present invention, at least one of the electrochemical cells contains at least one cathode according to the invention. Preferably, in electrochemical cells according to the present invention, the majority of the electrochemical cells contains a cathode according to the present invention. Even more preferably, in batteries according to the present invention all the electrochemical cells contain cathodes according to the present invention.

The present invention further provides for the use of batteries according to the invention in appliances, in particular in mobile appliances. Examples of mobile appliances are vehicles, for example automobiles, bicycles, aircraft or water vehicles such as boats or ships. Other examples of mobile appliances are those which move manually, for example computers, especially laptops, telephones or electric hand tools, for example in the building sector, especially drills, battery-powered screwdrivers or battery-powered staplers.

The invention is further illustrated by the following working examples.

### GENERAL

A JOEL-JSM6320F scanning electron microscope (SEM) with energy dispersive spectroscopy (EDS) capability was used to study the phase distribution, composition, rough estimate of primary particle size and surface morphology.

Percentages are % by weight unless specifically expressed otherwise.

I.1 Synthesis of a Precursor TM-OH.1, Step (a.1)

A 9-l-stirred reactor with overflow for removing mother liquor was filled with distilled water and 36.7 g of ammonium sulfate per kg of water. The solution was heated to 45° C. and the pH value is adjusted to 11.6 by adding an aqueous 25 wt. % of sodium hydroxide solution.

The precipitation reaction was started by the simultaneous feed of an aqueous transition metal solution and an alkaline precipitation agent at a flow rate ratio of 1.84, and a total flow rate resulting in a residence time of 5 hours. The transition metal solution contained the sulfates of Ni, Co and Mn at a molar ratio of 8:1:1 and a total transition metal concentration of 1.65 mol/kg. The alkaline precipitation agent consisted of 25 wt. % sodium hydroxide solution and 25 wt. % ammonia solution in a weight ratio of 8.29. The pH value was kept at 11.6 by the separate feed of 25 wt. % sodium hydroxide solution. Precursor TM-OH.1 was obtained by filtration of the resulting suspension, washed with distilled water, followed by drying at 120° C. in air over a period of 12 hours and sieving.

I.2 Conversion of TM-OH.1 into a Cathode Active Materials

I.2.1 Manufacture of a Comparative Cathode Active Material, C-CAM.1

In a SPEX CETRIPREP 8000 mixer/miller, 5 grams of TM-OH.1 were mixed mechanically with 1.4 grams of LiOH for 20 minutes. The resulting powdered mixture was then calcined in a muffle oven at 850° C. for 15 hours. The resulting C-CAM.1 was then cooled to 25° C. and ground in a mortar/pestle.

I.2.2 Manufacture of an Inventive Cathode Active Material, CAM.2

In a SPEX CETRIPREP 8000 mixer/miller, 5 grams of TM-OH.1 were mixed mechanically with 1.4 grams of LiOH and 0.1 g of K₂CO₃ (1.5% by weight) for 20 minutes. The resulting powdered mixture was then calcined in a muffle oven at 850° C. for 15 hours. The resulting CAM.2 was then cooled to 25° C. and ground in a mortar/pestle.

I.2.3 Manufacture of an Inventive Cathode Active Material, CAM.3

In a SPEX CETRIPREP 8000 mixer/miller, 5 grams of TM-OH.1 were mixed mechanically with 1.4 grams of LiOH and 0.1 g of K₂CO₃ (1.5% by weight) for 20 minutes. The resulting powdered mixture was then calcined in a muffle oven at 810° C. for 10 hours. The resulting CAM.3 was then cooled to 25° C. and ground in a mortar/pestle.

II. Testing of Cathode Active Materials

Inventive and comparative cathode active materials are studied for capacity levels and cycle life in CR2032 coin cells using lithium metal as counter electrode. The lithiated composite materials are formed into a cathode powder for testing by mixing with carbon Super 65 from Timcal (7.5 w %), graphite KS10 from Timcal (7.5%) and 6% PVDF (Kynar) binder. Anhydrous solvent (1-methyl-2pyrrolidinone) was then added to the powder mix to form a slurry. The slurry was then coated on an aluminum substrate. The coating was dried at 85° C. for several hours and calendared to the final thickness (about.60 μm).

In the coin cells, cathode and anode were separated by a microporous polypropylene separator (MTI corporation) that was wetted with electrolyte consisting of a 1M solution of LiPF₆ dissolved in a 1:1:1 volume mixture of ethylene carbonate (EC), dimethyl carbonate (DMC), and diethyl carbonate (DEC) from Novolyte Corporation. The cell was crimped and used to probe the capacity and cycle life of the lithiated composite material. Cell assembly and crimping was done in glove box.

Tests of the cathode materials were run at constant current charge and discharge (0.1 C) to determine capacity and cycleability using Solatron 1470 Battery Test Unit and Arbin Instruments battery testerpower system. The coin cells were charged and discharged at a voltage between 4.3V and 3.0V. The cycling performance test was performed with a charge and discharge current each at 18 mA/g.

Coin cells based on CAM.2 or CAM.3 displayed a superior performance over those based on CCAM.1.

1. A process for making lithiated transition metal oxide particles comprising the steps of:
(a) providing a particulate mixed transition metal precursor chosen from hydroxides, carbonates, oxyhydroxides, and oxides of TM, wherein TM is a combination of metals according to general formula (I)
(NiₐCo_{b}Mn_{c})_{1-d}M_{d} (I)
wherein a ranges from 0.6 to 0.95,
b ranges from 0.025 to 0.2,
c ranges from zero to 0.2, and
d ranges from zero to 0.1,
M is chosen from Mg, Al, Ti, Zr, Mo, W, Al, Mg, Nb, and Ta,
a+b+c=1,
(b) mixing the precursor with at least one compounds of lithium and 0.05 wt. % to 5 wt. % by weight at least of one processing additives chosen from potassium carbonate and potassium bicarbonate, the percentage referring to the entire mixture obtained in step (b), and
(c) treating the mixture obtained according to step (b) at a temperature from 700° C. to 1,000° C.

2. The process according to claim 1, wherein the compound of lithium is chosen from lithium oxide, lithium hydroxide, lithium carbonate, and lithium bicarbonate.

3. The process according to claim 1, wherein step (c) is performed in a roller hearth kiln, in a rotary kiln, in a pusher kiln, in a vertical, or tunnel kiln or in a pendulum kiln.

4. The process according to claim 1, wherein step (b) includes the addition adding and mixing of at least one compound of aluminum, titanium, or zirconium.

5. The process according to claim 1, wherein the processing additive has an average particle diameter (d50) ranging from 1 μm to 50 μm.

6. The process according to claim 1, wherein TM is chosen from Ni_{0.6}Co_{0.2}Mn_{0.2}, Ni_{0.7}Co_{0.2}Mn_{0.1}, Ni_{0.8}Co_{0.1}Mn_{0.1}, and Ni_{0.85}Co_{0.1}Mn_{0.05}.

7. The process according to claim 1, wherein step (c) is performed in air, oxygen enriched air, or oxygen atmosphere.

8. The process according to claim 1, wherein the process further comprises step (d):
d) treating the particulate material obtained from (c) with an aqueous medium, followed by removing the aqueous medium by a solid-liquid separation method.

9. A particulate electrode active material according to general formula Li₁₊ₓK_{y}TM_{1-x-y}O2,
wherein x ranges from zero to 0.2,
wherein y ranges from 0.002 to 0.1,
wherein TM is a combination of metals according to general formula (I)
(NiₐCo_{b}Mn_{c})_{1-d}M_{d} (I)
wherein
a ranges from 0.6 to 0.95,
b ranges from 0.025 to 0.2,
c ranges from zero to 0.2, and
d ranges from zero to 0.1,
M is chosen from Mg, Al, Ti, Zr, Mo, W, Al, Mg, Nb, and Ta,
a+b+c=1
and wherein an average diameter d50 of primary particles ranges from 2 μm to 15 μm.

10. The particulate electrode active material according to claim 9, wherein secondary particles are composed of 2 to 35 primary particles on average.

11. The particulate electrode active material according to claim 9, wherein potassium ions (K+) occupy lithium ion (Li+) sites in a crystal structure.

12. A method of using a particulate electrode active material according to claim 9 in a lithium ion battery.
